(19) United States
(12) Patent Application Publication
(10) Pub. No.: US 2024/0424574 A1
(43) Pub. Date: Dec. 26, 2024

(54) MACHINING DEVICE WITH DUAL USE FOR DRILLING AND LATHING

(71) Applicant: WEIHAI ALLWIN ELECTRICAL AND MECHANICAL TECH. CO., LTD, Weihai (CN)

(72) Inventors: Fei YU, Weihai (CN); Xuguang JING, Weihai (CN); Jian SUN, Weihai (CN); Xiuqiao SONG, Weihai (CN); Lixing CUI, Weihai (CN); Xinjie YU, Weihai (CN); Jingde WANG, Weihai (CN); Jialing LIU, Weihai (CN)

(21) Appl. No.: 17/913,792

(22) PCT Filed: May 7, 2022
(86) PCT No.: PCT/CN2022/091491

§ 371 Date: Sep. 22, 2022

(30) Foreign Application Priority Data
Jun. 15, 2021 (CN) 202121326867.8

(51) Int. Cl. B23B 23/00

(52) U.S. Cl. CPC B23B 23/005

(57) ABSTRACT

The utility model discloses a machining device having both a drill and a lathe. A handle (7) is fixed on the shell of the bench drill, a base (2) and a handle (7) of the bench drill are supported on the ground, a holding block (8) located on the left side of the crack lifting mechanism (5) is arranged on the guide rail (3), a tool rest & base assembly (9) is arranged on the top of the holding block (8); a support portion (10) is fixed on the top of the rocking lift mechanism, a tailstock assembly (11) is fixed on the top of the support portion (10), a tailstock spindle (12) is arranged in the tailstock assembly (11), a tailstock center (13) is inserted in the left port of the tailstock spindle (12), a tailstock hand wheel (14) is arranged on the right end of the tailstock assembly (11) for driving the tailstock spindle (12) to extent or retract, and a locking handle (15) for locking the tailstock spindle (12) is arranged on the tailstock assembly (11). The beneficial effects of the utility model are that: saving machining cost, drilling and shaping on a lathe, and suitable for machining manufacturers.

### TECHNICAL FIELD

The utility model relates to the technical field of mechanical equipment for drilled and lathed workpieces and, in particular, to a machining with dual use for drilling and lathing.

### BACKGROUND

In the manufacturing of workpiece, the vertical bench drill is usually used to obtain the required hole design on the workpiece, and the outer contour of the workpiece needs to be turned using a lathe after drilling, and thus the workpiece machining is finished. However, some machining manufacturers have only bench drills in place without lathes, and to shape the outer contour of the workpiece, they have no way but to outsource to other factories, which not only increases the manufacturing cost, but also lowering the production efficiency of the workpiece due to delays caused by outsourcing. Therefore, there is an urgent need for a dual-purpose machining device that can save on machining costs and is suitable for machining manufacturers that can both drill and shape on a lathe.

### SUMMARY

The aim of the utility model is to overcome the shortcomings of the prior art and to provide a compact, cost saving, and easy-to-operate machining device with dual use for drilling and lathing that can be used for both turning and drilling of workpieces.

The aim of the utility model can be realized through the following technical scheme: A machining device with dual use for drilling and lathing, comprising a horizontally placed bench drill, wherein a lifting handle is arranged at the upper end of the bench drill, a guide rail is arranged on the base of the bench drill, a toothed rack is arranged on the guide rail, a crank lifting mechanism is arranged on the guide rail which can move along the guide rail, and a crank is arranged on the crank lifting mechanism, wherein: a handle is fixed on the shell of the bench drill, a base and the handle of the bench drill are supported on the ground, a holding block located on the left side of the crack lifting mechanism is arranged on the guide rail, a tool rest & base assembly is arranged on the top of the holding block: a support portion is fixed on the top of the rocking lift mechanism, a tailstock assembly is fixed on the top of the support portion, a tailstock spindle is arranged in the tailstock assembly, a tailstock center is inserted in the left port of the tailstock spindle, a tailstock hand wheel is arranged on the right end of the tailstock assembly for driving the tailstock spindle to extend or retract, and a locking handle for locking the tailstock spindle is arranged on the tailstock assembly: the drill chuck of the bench drill is positioned at the same horizontal line as the tailstock center.

It further comprises a bench, and the bench is provided with a mounting hole that matches the tailstock spindle.

The holding block inside is provided with a through hole and a sliding chute, wherein the through hole is connected with the sliding chute, the through hole is matched with the guide rail, the sliding chute is matched with the toothed rack, the outer wall of the holding block is provided with an opening connecting the through hole, the side wall of the opening is provided with a threaded hole, the threaded hole inside is connected with a locking handle, and the holding block is clamped to the guide rail under the threaded connection force.

The two ends of the handle are respectively fixed on the two sides of the drill motor enclosure, and the handle and the base play a supporting role together when the device is used as a lathe: the handle can also be used as an auxiliary handle for setting down and erecting the device.

The guide rail is detachably connected to the base.

The top surface of the tailstock spindle is provided with a plane along its axial direction.

The base is an asymmetric structure, which realizes both functions as a lathe and a bench drill, saving raw materials.

The utility model has the following advantages: saving machining cost, drilling and shaping on a lathe, and suitable for machining manufacturers.

### BRIEF DESCRIPTION OF THE DRAWINGS

FIG. 1 is a schematic diagram of the installation of the utility model for use as a lathe;

FIG. 2 is a schematic diagram of the tailstock spindle;

FIG. 3 is a schematic diagram of the holding block;

FIG. 4 is a schematic diagram of the tailstock center;

FIG. 5 is a schematic diagram of the installation of the utility model for use as a bench drill;

FIG. 6 is a schematic diagram of the bench;

FIG. 7 is another schematic diagram of the bench; and

FIG. 8 is a schematic diagram of the installation of the bench and the tailstock spindle.

List of reference numerals: 1—Lifting handle, 2—Base, 3—Guide rail, 4—Toothed rack, 5—Crank lifting mechanism, 6—Crank, 7—Handle, 8—Holding block, 9—Tool rest and base assembly, 10—Support portion, 11—Tailstock assembly, 12—Tailstock spindle, 13—Tailstock center, 14—Tailstock hand wheel, 15—Locking handle, 16—Drill chuck, 17—Bench, 18—Mounting hole, 19—Through hole, 20—Sliding chute, 21—Locking lever, 22—Opening.

### DETAILED DESCRIPTION

The utility model will be described in further detail below with reference to the attached drawings, but the scope of protection of the utility model is not limited to the following:

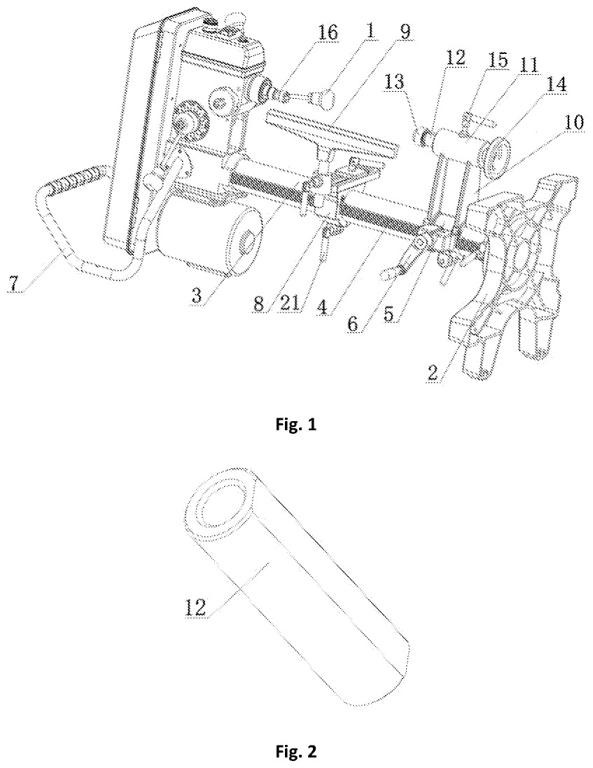

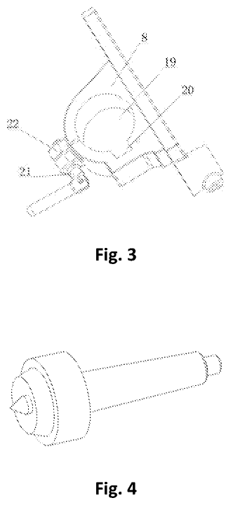

As illustrated in FIGS. 1 through 4, a machining device with dual use for drilling and lathing, comprising a horizontally placed bench drill, wherein a lifting handle 1 is arranged at the upper end of the bench drill, a guide rail 3 is arranged on the base 2 of the bench drill, a toothed rack 4 is arranged on the guide rail 3, a crank lifting mechanism 5 is arranged on the guide rail 3 which can move along the guide rail 3, and a crank 6 is arranged on the crank lifting mechanism 5, wherein: a handle 7 is fixed on the shell of the bench drill, a base 2 and the handle 7 of the bench drill are supported on the ground, a holding block 8 located on the left side of the crack lifting mechanism 5 is arranged on the guide rail 3, a tool rest & base assembly 9 is arranged on the top of the holding block 8; a support portion 10 is fixed on the top of the rocking lift mechanism, a tailstock assembly 11 is fixed on the top of the support portion 10, a tailstock spindle 12 is arranged in the tailstock assembly 11, a tailstock center 13 is inserted in the left port of the tailstock spindle 12, a tailstock hand wheel 14 is arranged on the right end of the tailstock assembly 11 for driving the tailstock spindle 12 to extend or retract, and a locking handle 15 for locking the tailstock spindle 12 is arranged on the tailstock assembly 11: the drill chuck 16 of the bench drill is positioned at the same horizontal line as the tailstock center 13.

It further comprises a bench 17, and the bench 17 is provided with a mounting hole 18 that matches the tailstock spindle 12. The holding block 8 inside is provided with a through hole 19 and a sliding chute 20, wherein the through hole 19 is connected with the sliding chute 20, the through hole 19 is matched with the guide rail 3, the sliding chute 20 is matched with the toothed rack 4, the outer wall of the holding block 8 is provided with an opening 22 connecting the through hole 19, the side wall of the opening 22 is provided with a threaded hole, the threaded hole inside is connected with a locking lever 21, and the holding block 8 is clamped to the guide rail 3 under the threaded connection force.

The two ends of the handle 7 are respectively fixed on the two sides of the drill motor enclosure, and the handle 7 and the base 2 play a supporting role together when the device is used as a lathe; the handle 7 can also be used as an auxiliary handle for setting down and erecting the device. The guide rail 3 is detachably connected to the base 2. The top surface of the tailstock spindle 12 is provided with a plane along its axial direction.

The base 2 is an asymmetric structure, which realizes both functions as a lathe and a bench drill, saving raw materials.

The working process of the utility model is as follows:

When this device is used as a lathe, it can be used for shaping workpieces by turning. Support the base 2 and handle 7 on the ground as shown in FIG. 1: the operator first removes the drill chuck 16, then connects the spindle center at the original installation position, inserts the left end of a cylindrical workpiece into the sharp portion of the spindle center, then the operator rotates the crank 6 to drive the tailstock assembly 11 to move to an appropriate position along the guide rail 3 in place, locks the lifting mechanism 5, then rotates the tailstock hand wheel 14 of the tailstock assembly 11, to cause the tailstock spindle 12 to extend to the left, allowing the tailstock spindle 12 to drive the tailstock center 13 to move to the left and when the sharp portion of the tailstock center 13 reaches the right end surface of the workpiece, the operator tightens the locking handle 15 located on the top surface of the tailstock assembly 11, fixes the tailstock spindle 12, so as to realize the loading of the workpiece; then the operator switches on the motor part of the bench drill to drive the spindle center to rotate, and the spindle center to drive the workpiece to rotate; then the operator loosens the locking lever 21 on the holding block 8, reciprocatedly slides the holding block 8, the holding block 8 reciprocates left and right along the guide rail 3, the left holding block 8 drives the tool rest and base assembly 9 to reciprocate left and right, and the lathe tool on the tool rest and base assembly 9 turns the outer contour of the workpiece, so as to complete the turning and shaping of the workpiece.

When this device is used as lathe, it can be used to drill holes on workpieces, and the drilling forms come in three types, resulting in improvement of the efficiency of perforating operation and the convenience of operation, which are as follows:
1. Install and fix workpiece in the drill chuck 16, take out the tailstock center 13, insert the drill bit into the tailstock spindle 12, shake the tailstock hand wheel 14 to drive the tailstock spindle 12 to extend, then bring along the drill bit to move towards the workpiece direction, so as to drill holes on the workpiece.
2. Install and fix workpiece in the drill chuck 16, take out the tailstock center 13, insert the drill bit into the tailstock spindle 12, shake the lifting handle 1 to drive the workpiece to move towards the drill bit direction, so as to drill holes on the workpiece.
3. Install and fix workpiece in the drill chuck 16, take out the tailstock center 13, insert the drill bit into the tailstock spindle 12, shake the crank 6 to drive the rotation of the turbine inside crank lifting mechanism 5 to bring along the bevel gear to move on the toothed rack 4, thus causing the crank lifting mechanism 5 to move to the left along the guide rail 3, the support portion 10 to move to the left, causing the tailstock assembly 11 to move towards the workpiece direction and the drill bit to move to the workpiece direction, so as to drill holes on the workpiece.

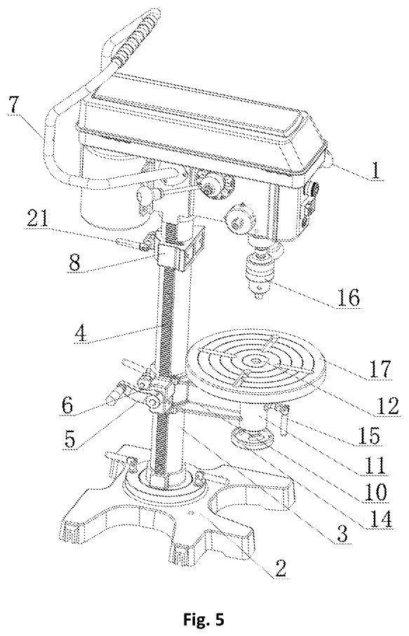

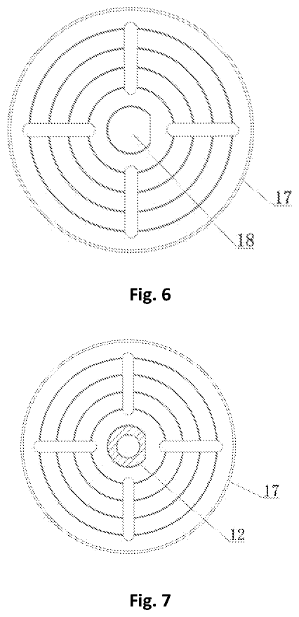

When this device is used as a bench drill, it can be used to drill holes on the workpiece. As shown in FIGS. 5 through 7, the operator lifts the bench drill through the handle 7 and supports the base 2 on the ground, then takes out the tailstock center 13 from the tailstock spindle 12, and after taking it out, sleeves the installation hole 18 of the bench 17 on the tailstock spindle 12, and supports the bench 17 on the top surface of the tailstock assembly 11, so as to complete the installation of the bench 17; install or place a vise on the bench 17 and fix the workpiece in the vise: install the drill bit in the drill chuck 16; the operator rotates the crank 6 to make the tailstock assembly 11 move upwards, and the tailstock assembly 11 drives the bench 17 to move upwards, so as to drive the clamped workpiece to move upwards. When the workpiece to be drilled is close to the drill bit, switch on the motor part of the bench drill, till it rotates, press the lifting handle 1 on the bench drill down and the drill extends down to allow drilling on the workpiece.

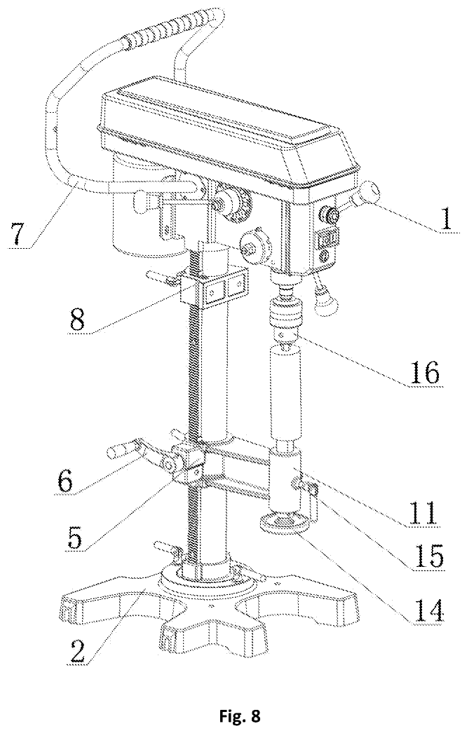

When this device is used as a bench drill, it can be used for sanding and polishing of workpieces. As shown in FIG. 8, disassemble the bench 17, install the tailstock center in the tailstock spindle 12, install the spindle center in the drill chuck 16, clamp the workpiece between the tailstock center and the spindle center, so as to sand and polish workpieces. This is a bench drill with full functions that common bench drills cannot realize.

It can be seen that the device can not only drill holes on the workpiece but also shape the workpiece by turning without outsourcing services, which greatly saves the manufacturing cost and improves the production efficiency. It is suitable for machining manufacturers without lathes.

Finally, it should be noted that: The foregoing is only a preferred embodiment of the utility model and is not intended to limit the utility model. Despite the detailed description of the utility model with reference to the preceding embodiments, it is still possible for a person skilled in the art to modify the technical solutions described in the preceding embodiments or to make equivalent replacements for some of the technical features. Any modification, equivalent replacement, improvement, etc. made within the spirit and principles of the utility model shall be included within the scope of protection of the utility model.

1. A machining device with dual use for drilling and lathing, comprising a horizontally placed bench drill, wherein a lifting handle is arranged at the upper end of the bench drill, a guide rail is arranged on the base of the bench drill, a toothed rack is arranged on the guide rail, a crank lifting mechanism is arranged on the guide rail which can move along the guide rail, and a crank is arranged on the crank lifting mechanism, wherein: a handle is fixed on the shell of the bench drill, a base and the handle of the bench drill are supported on the ground, a holding block located on the left side of the crack lifting mechanism is arranged on the guide rail, a tool rest & base assembly is arranged on the top of the holding block; a support portion is fixed on the top of the rocking lift mechanism, a tailstock assembly is fixed on the top of the support portion, a tailstock spindle is arranged in the tailstock assembly, a tailstock center is inserted in the left port of the tailstock spindle, a tailstock hand wheel is arranged on the right end of the tailstock assembly for driving the tailstock spindle to extend or retract, and a locking handle for locking the tailstock spindle is arranged on the tailstock assembly; the drill chuck of the bench drill is positioned at the same horizontal line as the tailstock center.

2. The machining device with dual use for drilling and lathing according to claim 1, further comprising a bench, wherein the bench is provided with a mounting hole that matches the tailstock spindle.

3. The machining device with dual use for drilling and lathing according to claim 2, wherein: the holding block inside is provided with a through hole and a sliding chute, wherein the through hole is connected with the sliding chute, the through hole is matched with the guide rail, the sliding chute is matched with the toothed rack, the outer wall of the holding block is provided with an opening connecting the through hole, the side wall of the opening is provided with a threaded hole, the threaded hole inside is connected with a locking lever, and the holding block is clamped to the guide rail under the threaded connection force.

4. The machining device with dual use for drilling and lathing according to claim 1, wherein: the two ends of the handle are respectively fixed on the two sides of the drill motor enclosure, and the handle and the base play a supporting role together when the device is used as a lathe; the handle can also be used as an auxiliary handle for setting down and erecting the device.

5. The machining device with dual use for drilling and lathing according to claim 1, wherein: the guide rail is detachably connected to the base.

6. The machining device with dual use for drilling and lathing according to claim 1, wherein: the top surface of the tailstock spindle is provided with a plane along its axial direction.

7. The machining device with dual use for drilling and lathing according to claim 1, wherein: the base is an asymmetric structure, which realizes both functions as a lathe and a bench drill, saving raw materials.
